(19) United States
(12) Patent Application Publication
(10) Pub. No.: US 2023/0134537 A1
(43) Pub. Date: May 4, 2023

(54) MATERIAL PROCESSING SYSTEM AND METHOD

(71) Applicant: HARDWOOD LINE MANUFACTURING, Chicago, IL (US)

(72) Inventors: Anton E. Lazaro, Evanston, IL (US); Frank C. Pusateri, Palatine, IL (US); Cesar Fuentes, Franklin Park, IL (US)

(21) Appl. No.: 17/975,286

(22) Filed: Oct. 27, 2022

Related U.S. Application Data
(60) Provisional application No. 63/272,724, filed on Oct. 28, 2021.

(51) Int. Cl. B01J 8/10; B01J 19/28

(52) U.S. Cl. CPC B01J 8/10; B01J 19/28; B01J 2208/00884; B01J 2219/182

(57) ABSTRACT

A material processing system includes a barrel line comprising one or more processing stations, wherein each processing station comprises a reservoir configured to hold a processing fluid, and a barrel assembly arranged within a first station of the barrel line, wherein the barrel assembly comprises a cylinder configured to receive material to be processed. The cylinder includes a first end surface, a second end surface, and a sidewall that extends therebetween, wherein the sidewall defines an opening therein configured to receive the material, and wherein at least one of the first end surface and the second end surface is perforated, and an inner wall configured to maintain the material within the cylinder when the cylinder rotates along a central axis in a first direction and to allow the material to exit the opening when the cylinder rotates along the central axis in an opposite direction.

### CROSS REFERENCE TO RELATED APPLICATIONS

The claims priority to U.S. Provisional Patent Application No. 63/272,724 filed Oct. 28, 2021. The entire disclosure contents of these applications are herewith incorporated by reference into the present application.

### BACKGROUND

### A. Field

This disclosure relates generally to material processing systems and methods, and more particularly to a system having a barrel line and a barrel assembly.

### B. Description of Related Art

In some material processing operations, a processing fluid chemically reacts with the material to chemically alter the material. For example, corroded parts may be inserted into a cleaning fluid to remove corrosion from the parts. In some cases, the material to be processed is inserted into a chamber and the chamber is lowered into the processing fluid. The chamber walls are perforated in such a way as to allow processing fluid to reach the material without allowing any egress of the material through the chamber walls. The chamber may be rotated to agitate the material to thereby encourage uniform processing of the material.

The chamber may be configured to accommodate processing materials of varying weights. For example, a chamber formed from a polymer material may have a wall thickness of one or more inches to accommodate processing of materials weighing in the hundreds of pounds. In these cases, the perforations formed in the walls are more aptly considered as channels that extend through the chamber walls. These channels can, however, tend to clog when the particles of the material are small (e.g., in the sub-millimeter range). This problem is exacerbated with heavier materials that exert increased forces on the particles of material, further urging the particles into the channels.

Various examples of material processing systems and methods that ameliorate these and other issues are described herein.

### SUMMARY

The following embodiments and aspects thereof are described and illustrated in conjunction with systems, tools and methods which are meant to be exemplary and illustrative, not limiting in scope.

In one aspect, a material processing system is disclosed. The material processing system includes a barrel line comprising one or more processing stations, wherein each processing station comprises a reservoir configured to hold a processing fluid, and a barrel assembly arranged within a first station of the barrel line, wherein the barrel assembly comprises a cylinder configured to receive material to be processed. The cylinder includes a first end surface, a second end surface, and a sidewall that extends therebetween, wherein the sidewall defines an opening therein configured to receive the material, and wherein at least one of the first end surface and the second end surface is perforated, and an inner wall configured to maintain the material within the cylinder when the cylinder rotates along a central axis in a first direction and to allow the material to exit the opening when the cylinder rotates along the central axis in an opposite direction.

In another aspect, a cylinder that facilitates processing a material is disclosed. The cylinder includes a first end surface, a second end surface, and a sidewall that extends therebetween, wherein the sidewall defines an opening therein configured to receive the material and wherein at least one of the first end surface and the second end surface is perforated, and an inner wall configured to maintain the material within the cylinder when the cylinder rotates along a central axis in a first direction and to allow the material to exit the opening when the cylinder rotates along the central axis in an opposite direction.

In yet another aspect, a method for processing material is disclosed. The method includes inserting a material into an opening in a sidewall of a cylinder of a barrel assembly. The cylinder includes a first end surface and a second end surface at respective ends of the sidewall, wherein at least one of the first end surface and the second end surface is perforated, and an inner wall configured to maintain the material within the cylinder when the cylinder rotates along a central axis in a first direction, and to allow the material to exit the opening when the cylinder rotates along the central axis in an opposite direction. The method also includes lowering the barrel assembly into a reservoir of a station of a barrel line, wherein the reservoir comprises a processing fluid, and rotating the cylinder in the first direction to process the material, wherein during rotation, processing fluid enters the opening in the sidewall and exits the at least one of the first end surface and the second end surface that is perforated.

### BRIEF DESCRIPTION OF THE FIGURES

The accompanying drawings and the drawings in the Appendix submitted herewith are included to provide a further understanding of the claims, are incorporated in, and constitute a part of this specification. The detailed description and illustrated examples described serve to explain the principles defined by the claims.

FIG. 1 illustrates a side view of a material processing system, in accordance with example embodiments.

FIG. 2A illustrates a front view of a barrel assembly, in accordance with example embodiments.

FIG. 2B illustrates a side view of the barrel assembly of FIG. 2A, in accordance with example embodiments.

FIG. 3A illustrates a perspective of a cylinder, in accordance with example embodiments.

FIG. 3B illustrates a cross-section of a side view of the cylinder of FIG. 3A, in accordance with example embodiments.

FIG. 4 illustrates material processing operations performed by a material processing system, in accordance with example embodiments.

FIG. 5 illustrates a rotational state diagram associated with states through which the cylinder transitions, in accordance with example embodiments.

FIG. 6 illustrates material processing operations performed by a material processing system, in accordance with example embodiments.

### DETAILED DESCRIPTION

Various examples of systems, devices, and/or methods are described herein. Words such as “example” and “exemplary” that may be used herein are understood to mean “serving as an example, instance, or illustration.” Any embodiment, implementation, and/or feature described herein as being an “example” or “exemplary” is not necessarily to be construed as preferred or advantageous over any other embodiment, implementation, and/or feature unless stated as such. Thus, other embodiments, implementations, and/or features may be utilized, and other changes may be made without departing from the scope of the subject matter presented herein.

Accordingly, the examples described herein are not meant to be limiting. It will be readily understood that the aspects of the present disclosure, as generally described herein, and illustrated in the figures, can be arranged, substituted, combined, separated, and designed in a wide variety of different configurations.

Further, unless the context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Moreover, terms such as “substantially,” or “about” that may be used herein, are meant that the recited characteristic, parameter, or value need not be achieved exactly, but that deviations or variations, including, for example, tolerances, measurement error, measurement accuracy limitations and other factors known to skill in the art, may occur in amounts that do not preclude the effect the characteristic was intended to provide.

An example of a material processing system comprises a barrel line and a barrel assembly. Some examples of the barrel line comprise one or more processing stations. Each processing station comprises a reservoir for holding a processing fluid. The barrel assembly is configured to be arranged within a first station of the barrel line. Some examples of the barrel assembly comprise a cylinder for receiving material to be processed. The cylinder comprises a first end surface, a second end surface, and a sidewall that extends therebetween. The sidewall defines an opening therein for receiving the material. At least one of the first end surface and the second end surface is perforated. The cylinder further comprises an inner wall configured to maintain the material within the cylinder when the cylinder rotates along a central axis in a first direction and to allow the material to exit the opening when the cylinder rotates along the central axis in the opposite direction.

During rotation of the material within the cylinder, the weight of the material is against the sidewall and the inner wall rather than the perforated end surfaces. This, in turn, keeps the perforations particle free.

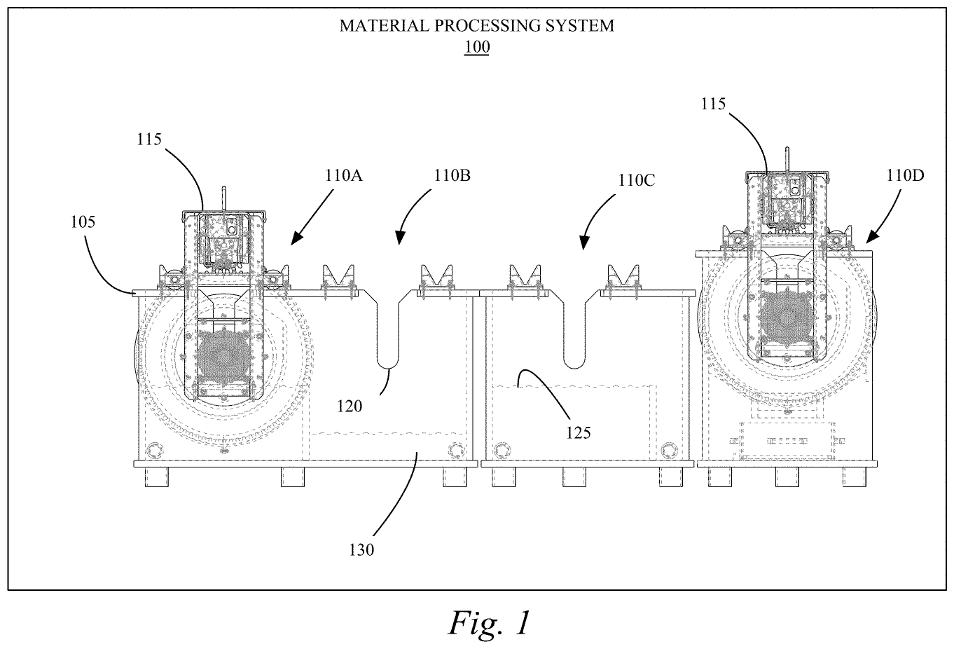

FIG. 1 illustrates a side view of an example of a material processing system 100. The material processing system 100 includes a barrel line 105 and a barrel assembly 115.

Some examples of the barrel line 105 include one or more processing stations 110. For example, the illustrated example includes four processing stations (110A-D). Each processing station 110 includes a reservoir configured to hold a processing fluid 130. Some examples of the reservoir define a square or rectangular volume (e.g., have four vertical sidewalls and a bottom/horizontal sidewall). Some examples of the reservoir define a cylindrical volume. In some examples of the reservoir, channels or slots are defined in a pair of opposing sidewalls or opposing sidewall regions. As described further below, the channels are configured to receive a shaft of the barrel assembly 115. Some examples of the reservoir do not include channels. In some of these examples, the shaft of the barrel assembly 115 is supported above or by a top edge of the reservoir. In other examples, the shaft is suspended within the reservoir (e.g., below the top edge of the reservoir).

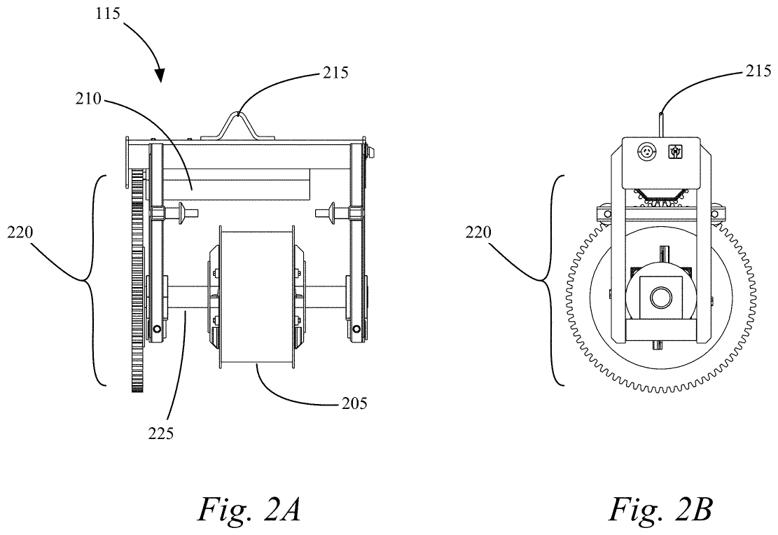

FIGS. 2A and 2B illustrate front and side views, respectively, of an example barrel assembly 115. The barrel assembly 115 includes a cylinder 205 configured to receive material to be processed. Some examples of the cylinder 205 are coupled to a shaft 225 that facilitates rotation of the cylinder 205 within the barrel assembly 115. In some examples, when the barrel assembly 115 is inserted into a station 110 of the barrel line 105, the shaft 225 fits within the channel 120 referred to above.

Some examples of the barrel assembly 115 include a handle 215 configured to facilitate lifting the barrel assembly 115 out of a first station 110A and lowering the barrel assembly 115 into a second station 110B Other examples of the barrel assembly 115 include hoist lift brackets that facilitate lifting the barrel assembly 115 via an automatic hoist.

Some examples of the barrel assembly 115 include a motor 210 configured to rotate the cylinder 205. Some examples of the barrel assembly 115 include a gear assembly 220 that rotationally couples a shaft of the motor 210 to the shaft 225 of the cylinder 205. For instance, in an example, a gear on a shaft of the motor 210 meshes either directly or via one or more intermediary gears with a gear on the shaft 225 of the cylinder 205. In some examples, the motor 210 drives the shaft 225 or the cylinder 205 via, for example, a belt, a chain, etc.

In some examples, the motor is part of the barrel line 105 rather than the barrel assembly 115. In some of these examples, the barrel assembly 115 comprises a gear assembly 220 configured to mesh with a corresponding gear of the motor. In some examples, the drive portion, e.g., one or more of the motor, gears, belt, etc., are on the inside of the barrel line 105 (e.g., within one or more of the reservoirs). In other examples, the drive portion, or a portion thereof, is on the outside of the barrel line 105.

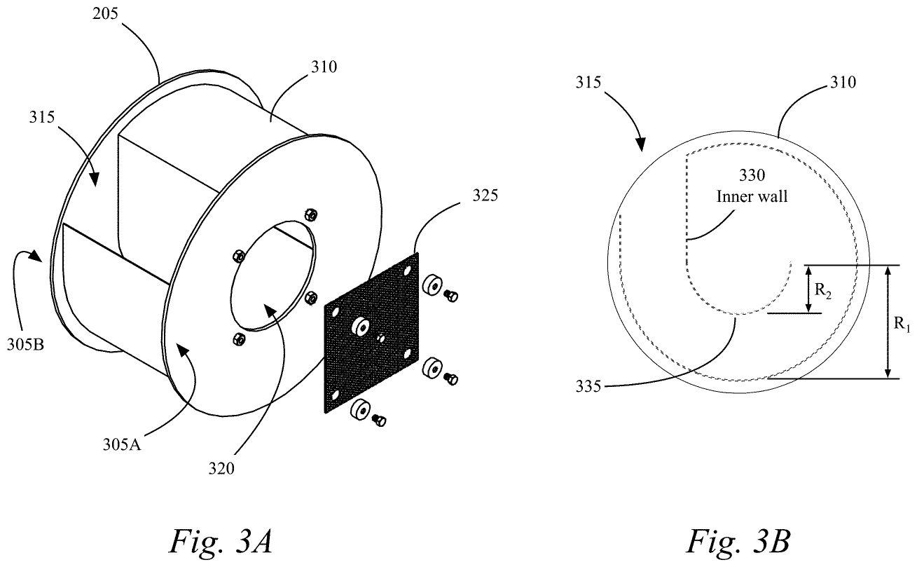

FIG. 3A illustrates a perspective of an example of a cylinder 205. FIG. 3B illustrates a cross-section of a side view of the cylinder 205. Some examples of the cylinder 205 include a first end surface 305A, a second end surface 305B, and a sidewall 310 that extends therebetween. Some examples of the sidewall 310 define an opening 315 therein for receiving material to be processed.

In some examples, at least one of the end surfaces 305 is perforated. For instance, in an example, the end surfaces 305 are solid structures having openings (e.g., perforations) formed therein. In another example, one or both end surfaces 305 define an opening 320 and screen 325 is arranged over the opening.

Some examples of the openings in the screen are sized to be a margin smaller than the size of the material to be processed to prevent the material from passing through the screen during processing operations. For instance, an example of the material to be processed has a particle size of about 1 mm and the openings in the screen have a diameter of about 0.9 mm. Other dimensions are contemplated. An example of the screen 325 is removably coupled to the end surface 305 to facilitate replacing the screen 325 with a screen having perforations of a different size.

Referring to FIG. 3B, some examples of the cylinder 205 include an inner wall 330 configured to maintain the material within the cylinder 205 when the cylinder 205 rotates along a central axis in a first direction and to allow the material to exit the opening 315 when the cylinder 205 rotates along the central axis in the opposite direction. This aspect is described in further detail below.

In some examples, the sidewall 310 of the cylinder 205 is a first radial distance R₁ from the central axis of the cylinder 205. In some examples, the inner wall 330 of the cylinder 205 defines a curved end region 335 that is a second radial distance R₂ from the central axis of the cylinder 205. An example of the curved end region 335 is configured so that the distance of the curved end region 335 to the sidewall 310 is relatively constant along the length of the curved end region 335. In some examples, the perforations in the end surface 305 are centrally arranged on the end surface 305 within a region defined by the second radial distance R₂. As described further below, when examples of these cylinders 205 are inserted in a station 110, the processing fluid 130 within the station 110 is set to a level that is between the first radial distance R₁ and the second radial distance R₂.

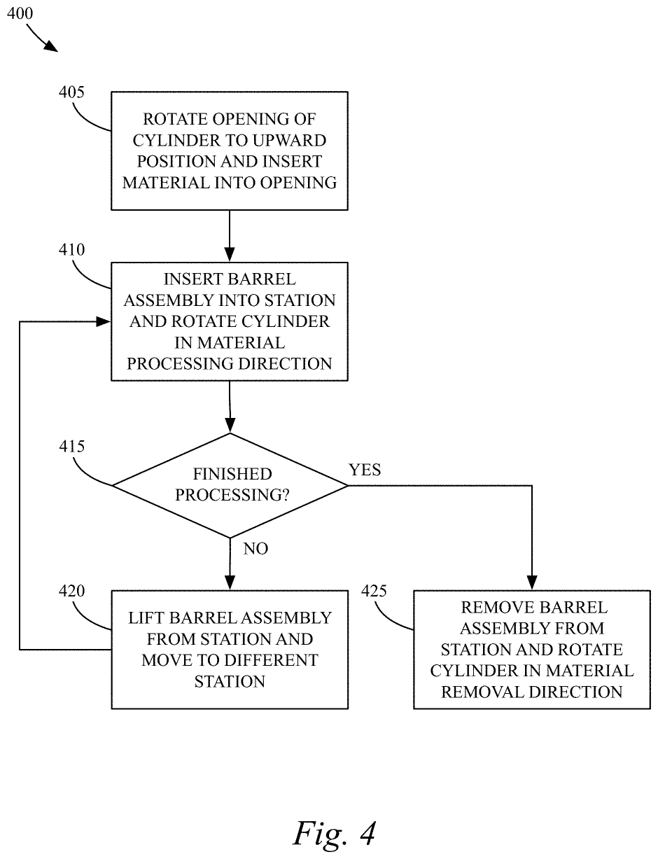

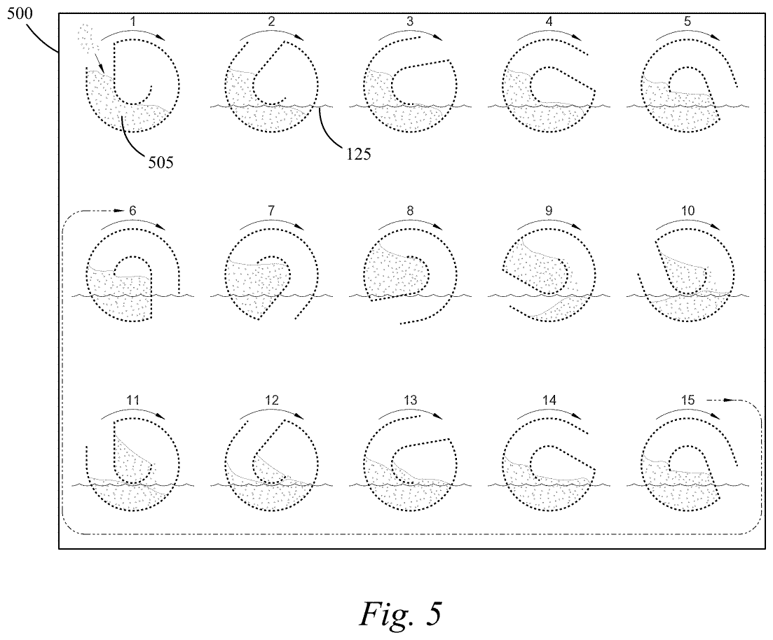

FIG. 4 illustrates examples of material processing operations 400 performed by the material processing system 100. In some examples, these operations are performed automatically (e.g., under computer control). The operations are best understood with reference to the rotational state diagram 500 of FIG. 5, which shows the cylinder 205 of the barrel assembly 115 in different rotational states. The operations at block 405 involve rotating the cylinder 205 of the barrel assembly 115 into a position that facilitates insertion of material 505 to be processed and inserting the material 505. An example of this state corresponds to the first rotational state (1) in the rotational state diagram 500. In some examples, the barrel assembly 115 is inserted into a first processing station 110A when rotated. In an example, the barrel assembly 115 is in communication with a controller that controls the cylinder 205 of the barrel assembly 115 to rotate to the appropriate position. In this regard, some examples of the barrel assembly 115 are configured to facilitate determining the particular orientation of the cylinder 205. For instance, some examples of the cylinder 205 include features (e.g., notches, magnets, etc.) that facilitate sensing by an appropriate sensor of the barrel assembly 115 the position and direction of rotation of the cylinder 205.

The operations at block 410 involve inserting the barrel assembly 115 (if not already inserted) into a reservoir of a station 110 of the barrel line 105 and rotating the cylinder 205 in a material processing direction. In some examples, the processing fluid 130 within the reservoir of the station 110 is set to a level 125 that is between the first radial distance R₁ associated with the sidewall 310 of the cylinder 205 and the second radial distance R₂ associated with the curved end region 335 of the inner wall 330 of the cylinder 205. This aspect is illustrated in the second rotational state in the rotational state diagram 500.

The material processing direction in this example is clockwise. As the cylinder 205 rotates, the material 505 follows the sidewall of the cylinder 205 and eventually hits the inner wall 330 when the cylinder 205 is in the fifth rotational state. Continued rotation causes the material 505 to pile against the curved section of the inner wall 330 (states seven and eight). Further rotation causes the material 505 to spill over the curved end region 335 of the inner wall 330 and onto the sidewall 310 of the cylinder 205. However, the opening 315 in the cylinder 205 at this stage of rotation is above the region where the material falls, and, therefore, the material is maintained within cylinder 205.

Rotation through states five through nine causes processing fluid 130 to be captured within the opening 315 of the cylinder 205. Continued rotation causes the processing fluid 130 to mix with the material 505 to thereby process the material 505 with the processing fluid 130. As the cylinder 205 continues to rotate, the processing fluid 130 within the mixture eventually drains/spills through perforations centrally arranged on the end surface 305 of the cylinder 205 and falls into the reservoir of the station 110.

If at block 415, further processing of the material 505 is required (e.g., processing by a different liquid), then at block 420, the barrel assembly 115 is lifted from the station 110 and moved to a different station 110. The operations at block 410 are then performed. In some examples, the lifting and the lowering of the barrel assembly 115 from one station 110 to the next station 110 is performed automatically. For instance, a computer system determines that processing of the material 505 is complete (e.g., the cylinder 205 has been rotated for a pre-determined amount of time) and then controls a hoist to lift/lower the barrel assembly 115 from one station 110 to the other station 110. In some examples, one or more of these aspects is performed manually.

If at block 415, processing of the material 505 is complete, then at block 425, the barrel assembly 115 is removed from the station 110, and the cylinder 205 is rotated in a direction that causes the material 505 to fall out of the opening 315 of the cylinder 205. Continuing with the example above, rotating the cylinder 205 in the counterclockwise direction causes the material 505 to fall out of the opening 315 of the cylinder 205.

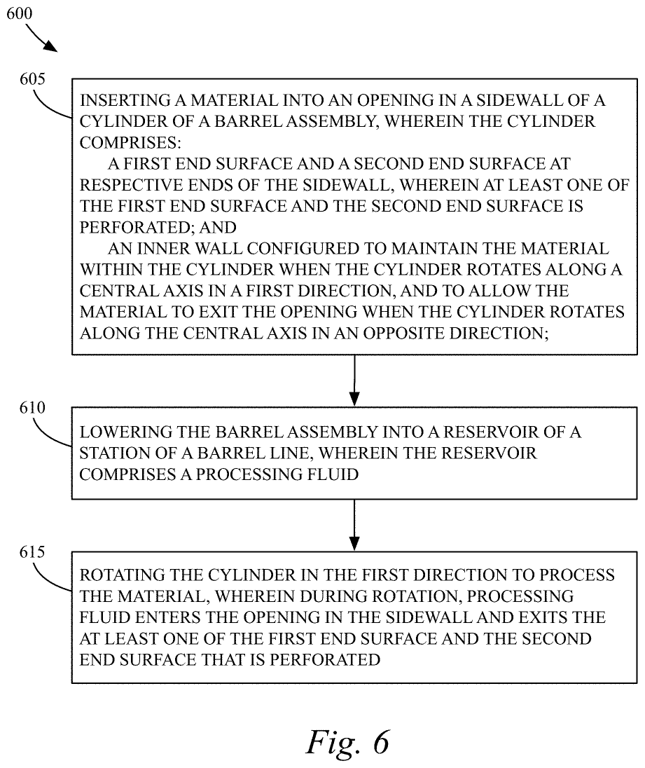

FIG. 6 illustrates examples of material processing operations 600 performed by a material processing system. The operations at block 605 involve inserting a material 505 into an opening 315 in a sidewall 310 of a cylinder 205 of a barrel assembly 115. Some examples of the cylinder 205 comprise a first end surface 305A and a second end surface 305B at respective ends of the sidewall 310. At least one of the first end surface 305A and the second end surface 305B is perforated. Some examples of the cylinder 205 further comprise an inner wall 330 configured to maintain the material 505 within the cylinder 205 when the cylinder 205 rotates along a central axis in a first direction and to allow the material 505 to exit the opening 315 when the cylinder 205 rotates along the central axis in the opposite direction.

The operations at block 610 involve lowering the barrel assembly 115 into a reservoir of a station 110 of a barrel line 105. The reservoir comprises a processing fluid 130.

The operations at block 615 involve rotating the cylinder 205 in the first direction to process the material 505. During rotation, processing fluid 130 enters the opening 315 in the sidewall 310 of the cylinder 205 and exits the at least one of the first end surface 305A and the second end surface 305B that is perforated.

In some examples, the sidewall 310 of the cylinder 205 is a first radial distance from the central axis of the cylinder 205, and the inner wall 330 of the cylinder 205 defines a curved end region 335 that is a second radial distance from the central axis of the cylinder 205. In these examples, the operations further involve filling the processing fluid 130 to a level that is between the first radial distance and the second radial distance from the central axis of the cylinder 205.

In some examples, each reservoir comprises a pair of opposing sidewalls having formed therein a channel 120 configured to receive a shaft 225 of the barrel assembly 115 about which the cylinder 205 rotates. In these examples, lowering the barrel assembly 115 into the reservoir of the station 110 of the barrel line 105 further involves lowering the shaft 225 into the channel.

Some examples of the operations further involve, after rotating the cylinder 205 in the first direction to process the material 505, inserting the barrel assembly 115 into a reservoir of a second station 110B of the barrel assembly 115 that comprises a second processing fluid 130, and rotating the cylinder 205 in the first direction in the reservoir of the second station 110B to perform a second processing operation on the material 505.

In some examples, the at least one of the first end surface 305A and the second end surface 305B that is perforated comprises a removable screen 325. In these examples, the openings in the screen 325 are a margin smaller than the material 505 to prevent the material 505 from passing through the screen 325.

In some examples, the particle size of the material 505 is about 1 mm.

In some examples, the barrel assembly 115 comprises a motor 210 configured to rotate the cylinder 205. In these examples, rotating the cylinder 205 in the first direction to process the material 205 involves actuating the motor 210.

In some examples, the barrel line 105 comprises a motor and the barrel assembly 115 comprises a gear assembly 220 configured to mesh with the motor. In these examples, rotating the cylinder 205 in the first direction to process the material 505 involves actuating the motor.

While the systems and methods of operation have been described with reference to certain examples, it will be understood by those skilled in the art that various changes can be made and equivalents can be substituted without departing from the scope of the claims. Therefore, it is intended that the present methods and systems not be limited to the particular examples disclosed, but that the disclosed methods and systems include all embodiments falling within the scope of the appended claims.

1. A material processing system comprising:
a barrel line comprising one or more processing stations, wherein each processing station comprises a reservoir configured to hold a processing fluid; and
a barrel assembly arranged within a first station of the barrel line, wherein the barrel assembly comprises a cylinder configured to receive material to be processed, wherein the cylinder comprises:
a first end surface, a second end surface, and a sidewall that extends therebetween, wherein the sidewall defines an opening therein configured to receive the material and wherein at least one of the first end surface and the second end surface is perforated;
an inner wall configured to maintain the material within the cylinder when the cylinder rotates along a central axis in a first direction and to allow the material to exit the opening when the cylinder rotates along the central axis in an opposite direction.

2. The material processing system according to claim 1, wherein the sidewall of the cylinder is a first radial distance from the central axis of the cylinder and wherein the inner wall of the cylinder defines a curved end region that is a second radial distance from the central axis of the cylinder, wherein the processing fluid is set to a level that is between the first radial distance and the second radial distance from the central axis of the cylinder.

3. The material processing system according to claim 1, wherein each reservoir comprises a pair of opposing sidewalls having formed therein a channel configured to receive a shaft of the barrel assembly about which the cylinder rotates.

4. The material processing system according to claim 1, wherein a first material processing operation is performed in a first station, wherein the barrel assembly is configured to be lifted out of the first station and lowered into a second station to perform a second material processing operation.

5. The material processing system according to claim 1, wherein the at least one of the first end surface and the second end surface that is perforated comprises a removable screen, wherein openings in the screen are a margin smaller than the material to prevent the material from passing through the screen.

6. The material processing system according to claim 5, wherein a particle size of the material is a margin larger than the screen perforation.

7. The material processing system according to claim 1, wherein the barrel assembly comprises a motor configured to rotate the cylinder.

8. The material processing system according to claim 1, wherein the barrel line comprises a motor and wherein the barrel assembly comprises a gear assembly configured to mesh with the motor.

9. A cylinder that facilitates processing a material, the cylinder comprising:
a first end surface, a second end surface, and a sidewall that extends therebetween, wherein the sidewall defines an opening therein configured to receive the material and wherein at least one of the first end surface and the second end surface is perforated; and
an inner wall configured to maintain the material within the cylinder when the cylinder rotates along a central axis in a first direction and to allow the material to exit the opening when the cylinder rotates along the central axis in an opposite direction.

10. The material processing system comprising according to claim 1, wherein the sidewall of the cylinder is a first radial distance from the central axis of the cylinder and wherein the inner wall of the cylinder defines a curved end region that is a second radial distance from the central axis of the cylinder, wherein the cylinder is configured to be partially submerged within a processing fluid so that a level of the processing fluid is between the first radial distance and the second radial distance from the central axis of the cylinder.

11. The material processing system comprising according to claim 1, wherein the at least one of the first end surface and the second end surface that is perforated comprises a removable screen, wherein openings in the screen are a margin smaller than the material to prevent the material from passing through the screen.

12. The material processing system comprising according to claim 11, wherein a particle size of the material is a margin larger than the screen perforation.

13. The material processing system comprising according to claim 1, wherein the barrel assembly comprises a motor configured to rotate the cylinder.

14. A method for processing material, the method comprising:
inserting a material into an opening in a sidewall of a cylinder of a barrel assembly, wherein the cylinder comprises:
a first end surface and a second end surface at respective ends of the sidewall, wherein at least one of the first end surface and the second end surface is perforated; and
an inner wall configured to maintain the material within the cylinder when the cylinder rotates along a central axis in a first direction, and to allow the material to exit the opening when the cylinder rotates along the central axis in an opposite direction;
lowering the barrel assembly into a reservoir of a station of a barrel line, wherein the reservoir comprises a processing fluid; and
rotating the cylinder in the first direction to process the material, wherein during rotation, processing fluid enters the opening in the sidewall and exits the at least one of the first end surface and the second end surface that is perforated.

15. The method according to claim 14, wherein the sidewall of the cylinder is a first radial distance from the central axis of the cylinder and wherein the inner wall of the cylinder defines a curved end region that is a second radial distance from the central axis of the cylinder, wherein method further comprises filling the processing fluid to a level that is between the first radial distance and the second radial distance from the central axis of the cylinder.

16. The method according to claim 14, wherein each reservoir comprises a pair of opposing sidewalls having formed therein a channel configured to receive a shaft of the barrel assembly about which the cylinder rotates, wherein lowering the barrel assembly into the reservoir of the station of the barrel line, further comprises lowering the shaft into the channel.

17. The method according to claim 14, further comprising:
after rotating the cylinder in the first direction to process the material, inserting the barrel assembly into a reservoir of a second station of the barrel assembly that comprises a second processing fluid; and
rotating the cylinder in the first direction in the reservoir of the second station to perform a second processing operation on the material.

18. The method according to claim 14, wherein that at least one of the first end surface and the second end surface that is perforated comprises a removable screen, wherein openings in the screen are a margin smaller than the material to prevent the material from passing through the screen.

19. The method according to claim 14, wherein the barrel assembly comprises a motor configured to rotate the cylinder, wherein rotating the cylinder in the first direction to process the material comprises actuating the motor.

20. The method according to claim 14, wherein the barrel line comprises a motor and wherein the barrel assembly comprises a gear assembly configured to mesh with the motor, wherein rotating the cylinder in the first direction to process the material comprises actuating the motor.
